(19) United States
(12) Patent Application Publication
(10) Pub. No.: US 2007/0266952 A1
(43) Pub. Date: Nov. 22, 2007

(54) Sturdi bowl

(76) Inventor: Rick Cruse, Hutchinson, KS (US)

Correspondence Address: Rick Cruse, 1123 E. 4th, Hutchinson, KS, 67501, US

(21) Appl. No.: 11/436,070

(22) Filed: May 18, 2006

(51) Int. Cl. A01K 5/01

(52) U.S. Cl. 119/61.54

(57) ABSTRACT

Sturdi Bowl, invented by Rick Cruse, Unites States citizen and Kansas resident, at 1123 East 4^{th}, Hutchinson, Kans. 67501, was designed to allow pet owners to provide food and water to their pets, outside, without risk of loss and mess. The Sturdi Bowl can be secured by pressing the unit's evenly spaced spikes easily into the ground. This system was designed for use outdoors, and can be used in a variety of situations, such as camping, traveling and outdoor lounging. This invention is similar in appearance to outdoor pet dishes, but has a unique rounded design that prevents chains, leashes and cables from becoming snagged under the lip or rim of the bowls. The bowl is currently manufactured out of durable extruded plastic materials, but can be made with just about any durable weatherproof material.

### OTHER LIKE INVENTIONS

Applicant is unaware of any nonprovisional utility patent application claiming the benefit of one or more prior filed copending nonprovisional applications (or international applications designating the United States of America) under 35 USC Sec.s 120, 121 or 365(c).

### BACKGROUND OF INVENTION

Pets require food or water when they are at play and at rest outside. However, most pets are outdoors on chains, leashes or runner cables. These restraints keep the pets in the yard, but are awkward and can lead to spilled food and water as pets run past their feeding bowls, dragging their tethers into them. The spilled water and food attracts a variety of pests and causes a mess, in addition to waste of good food. Until now, pet owners have had no solutions in this situation. With the Sturdi Bowl, pet owners can secure the pet bowls into the ground and eliminate accidental spills and tip-overs.

### SOLUTION

The Sturdi Bowl was designed to allow pet owners to provide food and water to their beloved pets while they are outside without risk of loss and mess. With this unique design, the bowls can be placed outside without the concern of tipped food and water. This superb design is convenient for pet owners to use while camping, traveling, or leaving their pets temporarily outdoors while the pets may need food and water.

### DETAILED DESCRIPTION OF INVENTION

With the Sturdi Bowl, pet owners can secure the pet bowls into the ground and eliminate accidental spills and emptying. The Sturdi Bowl secures pet food and water dishes into the ground to prevent spills and wasted food and water, incorporating a series of evenly spaced spikes that can be driven easily into the ground. This system was designed for use outdoors, and can be used in a variety of situations, such as camping, traveling and outdoor lounging. The bowl comes in a variety of sizes and models and can be made to hold either food or water, or both. This invention is similar in appearance to outdoor pet dishes, but has a unique rounded design that prevents chains, leashes and cables from becoming snagged under the lip or rim of the bowls. The bottom of the bowl has sturdy stakes that can be pressed easily into the ground. These stakes are manufactured in a variety of sizes to provide complete security for both small and large bowls. The bowl is currently manufactured out of durable extruded plastic materials, but can be made with just about any durable weatherproof material. The bowls are offered in a variety of colors to suit any pet owner's needs. Pets and their owners will howl for this unique invention.

### DETAILED DESCRIPTION OF DRAWINGS ATTACHED

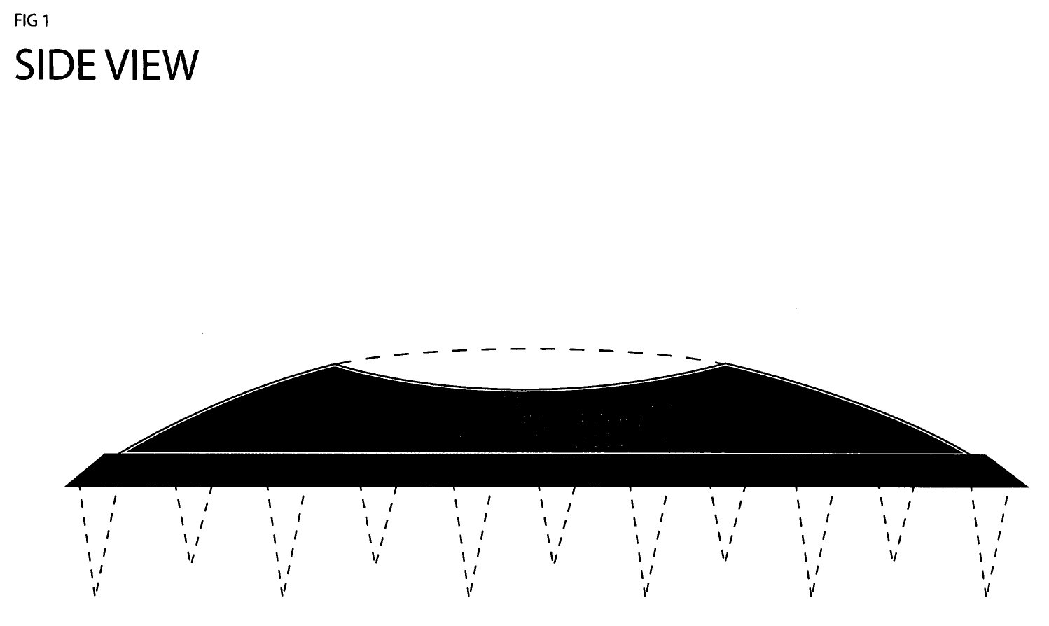

FIG. 1 is a drawing of a side perspective of the Sturdi Bowl. Illustrated are the stakes on the bottom of the bowl that anchor the bowl to the ground to prevent movement.

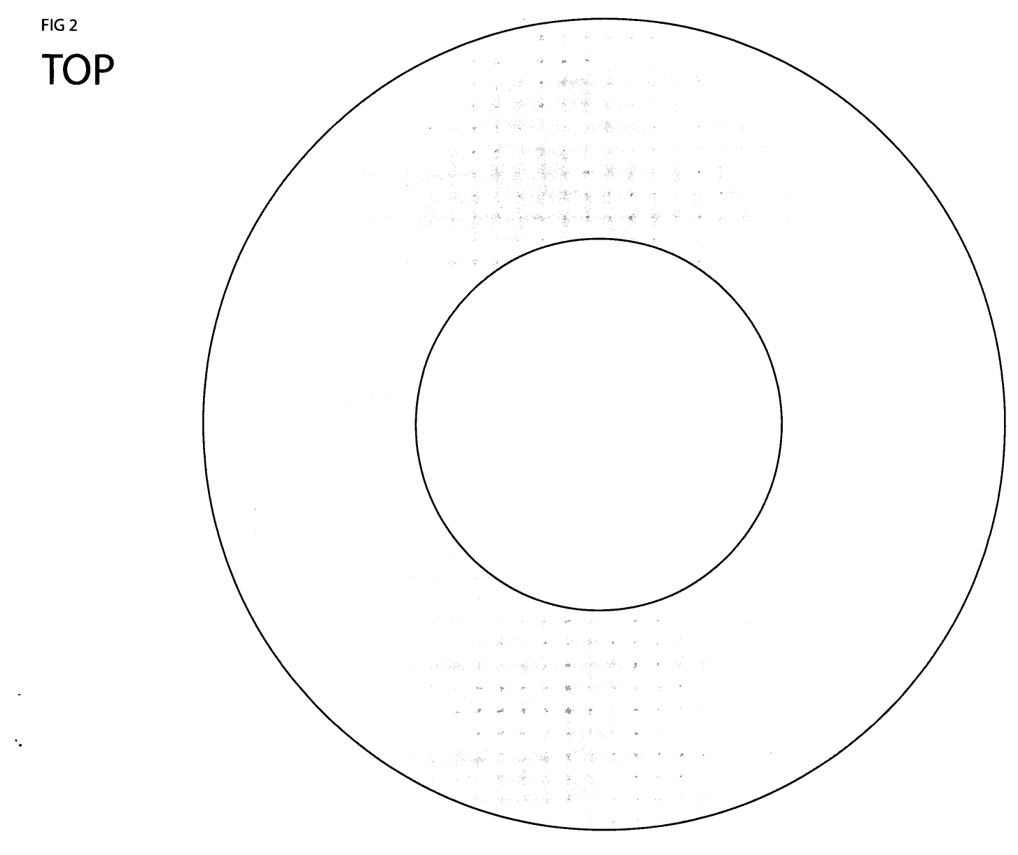

FIG. 2 is a top view of the invention. The unique rounded design of this bowl also prevents the pets' chains from snagging on the bowl.

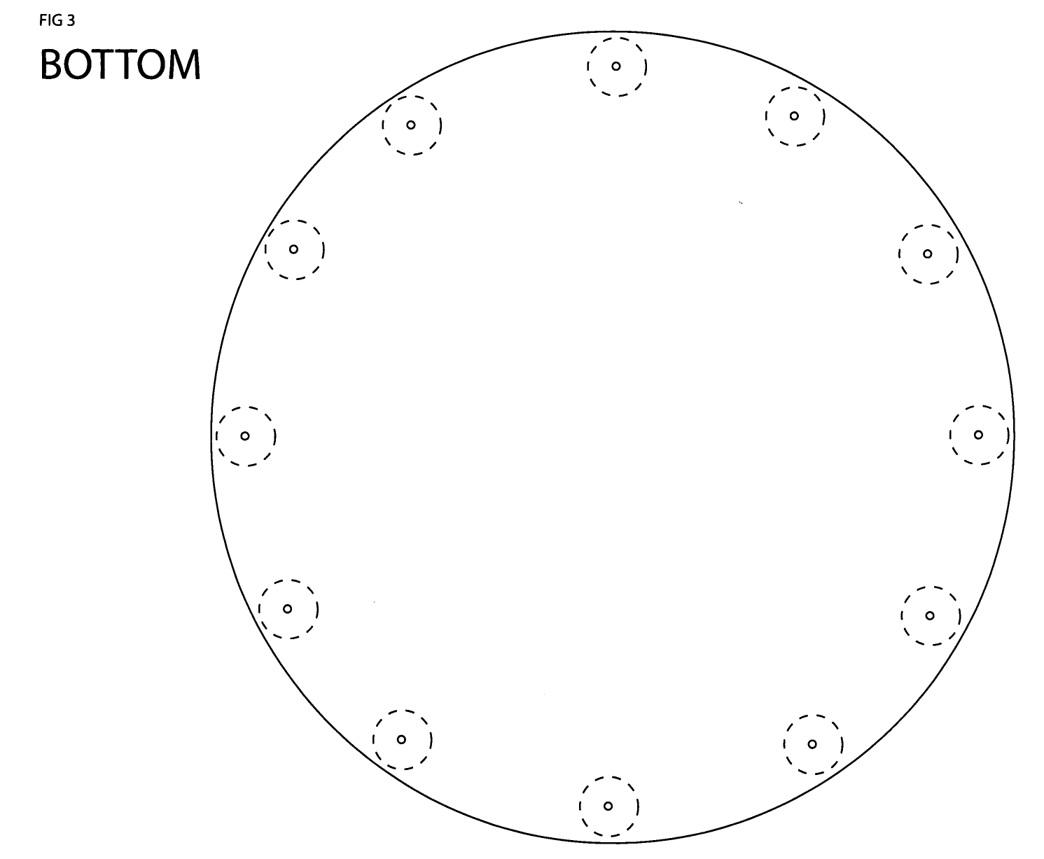

FIG. 3 is a drawing of the bottom of the bowl, looking at the points of the stakes.

1. The Sturdi Bowl secures pet food and water dishes into the ground to prevent spills and wasted food and water, incorporating a series of evenly spaced spikes that can be driven easily into the ground. This system was designed for use outdoors, and can be used in a variety of situations, such as camping, traveling and outdoor lounging. The bottom of the bowl has sturdy stakes that can be pressed easily into the ground. These stakes are manufactured in a variety of sizes to provide complete security for both small and large bowls.

2. This invention is similar in appearance to outdoor pet dishes, but has a unique rounded design that prevents chains, leashes and cables from becoming snagged under the lip, or rim of the bowls.
